(19) United States
(12) Patent Application Publication
(10) Pub. No.: US 2007/0094109 A1
(43) Pub. Date: Apr. 26, 2007

(54) Time and attendance method and system

(75) Inventor: Brent Perry, Tulsa, OK (US)

Correspondence Address: DICKINSON WRIGHT PLLC, 1901 L. STREET NW, SUITE 800, WASHINGTON, DC, 20036, US

(73) Assignee: Staffmetric, LLC, Tulsa, OK (US)

(21) Appl. No.: 11/246,311

(22) Filed: Oct. 11, 2005

(51) Int. Cl. G06F 15/02

(52) U.S. Cl. 705/32

(57) ABSTRACT

The present invention relates to a method of generating a GUI screen, for time and attendance, including displaying a timesheet in a graphical bar format; receiving time entries in the timesheet; displaying the time entries along the graphical bar; and totaling the time entries. The time entries are displayed in real time, and can be received from either a web-based application, a biometric device, or an interactive voice response system. The graphical bar format includes differing portions displaying different shift periods and overtime. A timesheet can be displayed in a standard column format for the user, whereas other users only view the graphical bar format in real time. A plurality of screens can be displayed for viewing by a plurality of different users, wherein the screens can be displayed simultaneously; and wherein the screens are displayed in real time.

The present invention relates to a method and apparatus for providing web-based time and attendance for workers. In particular, the present method and system is used in the temporary staffing industry.

### BACKGROUND OF THE INVENTION

Time and attendance for workers is usually conducted in paper format (i.e., paper timesheets), or by clocking in/out using a paper/time punch machine. However, since these activities are conducted on paper and thus, are labor-intensive, collecting and collating papers is a difficult task, and can be inaccurate.

Accordingly, a method of using the Internet and other advances in the identification of users (i.e., web applications with passwords, biometrics, etc.), to determine quickly and accurately an employee's working status, and to speed up the accounting process for such entered time, is needed.

### SUMMARY OF THE INVENTION

The present invention relates to a method of generating a screen, particularly a Graphical User Interface (GUI) screen, for time and attendance, and includes the steps of displaying a timesheet in a graphical bar; receiving time entries-in the timesheet; displaying the time entries along the graphical bar; and totaling the time entries.

In one embodiment consistent with the present invention the time entries are displayed in real time to a user.

In another embodiment consistent with the present invention, the time entries are received from a web-based application, a biometric device, and an interactive voice response system.

In yet another embodiment consistent with the present invention, the time entries are viewed in real time by other users.

In yet another embodiment consistent with the present invention, the graphical bar includes differing portions displaying different shift periods.

In yet another embodiment consistent with the present invention, the differing portions include one of differently colored and shaded portions.

In yet another embodiment consistent with the present invention, the graphical bar includes differing portion displaying overtime.

In yet another embodiment consistent with the present invention, the method includes displaying a working status of the employee, and displaying a job order being worked by the employee.

In yet another embodiment consistent with the present invention, the timesheet is for a plurality of employees working on a plurality of job orders.

In yet another embodiment consistent with the present invention, the timesheet can be populated for a standard number of working day hours by inputting one time entry.

In yet another embodiment consistent with the present invention, a predetermined time period can be viewed up to and including current time, wherein current time is displayed as one of a vertical line which moves across the screen as time progresses, and as a different shading on said graphical bar, and the predetermined time period is a current pay period.

In yet another embodiment consistent with the present invention, the biometric system allows a feature of a user's physical appearance to be scanned into the system for purposes of identification; and the system notes a time scanned for purposes of time and attendance. The time scanned is entered into the timesheet as a time entry for display in the graphical bar format

In yet another embodiment consistent with the present invention, an interactive voice response system receives input from a user for identification purposes; and the system receives information from the user for purposes of time and attendance. The input and the information are processed using a speech recognition mechanism.

In yet another embodiment consistent with the present invention, the system provides the user with information on their current working status.

In yet another embodiment consistent with the present invention, the time entries are exported to an accounting program.

In yet another embodiment consistent with the present invention, the method includes receiving expense entries; and forwarding the expense entries for approval.

In yet another embodiment consistent with the present invention, a method of generating a GUI screen for time and attendance, includes displaying a timesheet in a standard column format; receiving time entries in the timesheet from a user; and displaying the timesheet with the time entries to other users in a graphical bar format.

In yet another embodiment consistent with the present invention, a method of generating a GUI for time and attendance, includes displaying a plurality of screens for viewing by a plurality of different users, the screens including a clients screen, an employees screen, a job orders screen, a cutoff screen, and a reports screen; wherein the screens can be displayed simultaneously; and wherein the screens are displayed in real time.

In yet another embodiment consistent with the present invention, a computer system having a program for generating screens for time and attendance, includes means for displaying a timesheet in a graphical bar; means for receiving time entries in the timesheet; means for displaying the time entries along the graphical bar; and means for totaling the time entries.

In yet another embodiment consistent with the present invention, a computer system having a program for generating screens for time and attendance, includes means for displaying a timesheet in a standard column format; means for receiving time entries from a user in the timesheet; and means for displaying the timesheet with the time entries to other users in a graphical bar format.

In yet another embodiment consistent with the present invention, a computer system having a program for generating screens for time and attendance, includes means for displaying a plurality of screens for viewing by a plurality of different users, the screens including a clients screen, an employees screen, a job orders screen, a cutoff screen, and a reports screen; wherein the screens can be displayed simultaneously; and wherein the screens are displayed in real time.

In yet another embodiment consistent with the present invention, a computer system for generating screens for time and attendance, includes at least one memory containing at least one program including the steps of: displaying a timesheet in a graphical bar; receiving time entries in the timesheet; displaying the time entries along the graphical bar; and totaling the time entries; and at least one processor for running the program.

In yet another embodiment consistent with the present invention, a computer system for generating screens for time and attendance, includes at least one memory containing at least one program including the steps of: displaying a timesheet in a standard column format; receiving time entries from a user in the timesheet; and displaying the timesheet with the time entries to other users in a graphical bar format; and at least one processor for running the program.

In yet another embodiment consistent with the present invention, a computer system for generating screens for time and attendance, includes at least one memory containing at least one program including the steps of: displaying a plurality of screens for viewing by a plurality of different users, the screens including a clients screen, an employees screen, a job orders screen, a cutoff screen, and a reports screen; wherein the screens can be displayed simultaneously; and wherein the screens are displayed in real time; and at least one processor for running the program.

In yet another embodiment consistent with the present invention, a computer-readable medium whose contents cause a computer system to generate screens for time and attendance, the computer system having a program including the steps of: displaying a timesheet in a graphical bar; receiving time entries in the timesheet; displaying the time entries along the graphical bar; and totaling the time entries.

In yet another embodiment consistent with the present invention, a computer-readable medium whose contents cause a computer system to generate screens for time and attendance, the computer system having a program including the steps of: displaying a timesheet in a standard column format; receiving time entries from a user in the timesheet; and displaying the timesheet with the time entries to other users in a graphical bar format.

In yet another embodiment consistent with the present invention, a computer-readable medium whose contents cause a computer system to generate screens for time and attendance, the computer system having a program including the steps of: displaying a plurality of screens for viewing by a plurality of different users, the screens including a clients screen, an employees screen, a job orders screen, a cutoff screen, and a reports screen; wherein the screens can be displayed simultaneously; and wherein the screens are displayed in real time.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic of a client-server arrangement according to one embodiment consistent with the present invention.

FIG. 2 is a graphical display of a standard timesheet according to one embodiment consistent with the present invention.

FIG. 3 is a graphical display of an advanced timesheet according to one embodiment consistent with the present invention.

FIG. 4 is a graphical display of a hybrid timesheet according to one embodiment consistent with the present invention.

FIG. 5 is a graphical display of a group timesheet according to one embodiment consistent with the present invention.

FIG. 6 is a list of employee activity according to one embodiment consistent with the present invention.

### DETAILED DESCRIPTION OF THE INVENTION

The present invention relates to a method and apparatus for providing web-based time and attendance, in particular for the temporary staffing industry.

In one embodiment consistent with the present invention, a corporate entity would utilize the present invention to have temporary workers input their time and attendance data on-line. For example, in one embodiment, a staffing company would be used to approve timesheet data from the workers, and then the staffing company would provide it to the corporate entity.

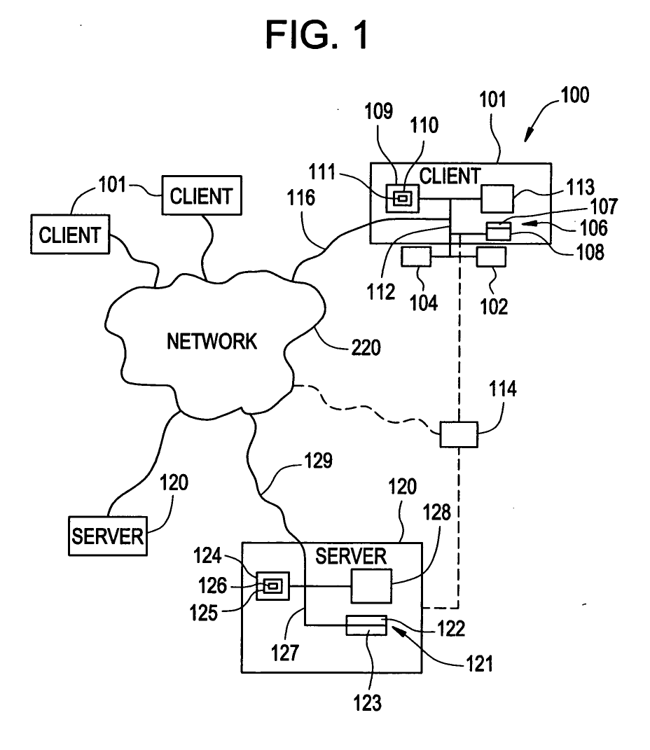

In one embodiment consistent with the present invention, the architecture of the system includes a system 100 (see FIG. 1) which includes a client computer 101, such as a personal computer (PC), with display or monitor 102 and input means 104. However, the client 101 may be a mobile terminal, such as a mobile computing device, or a mobile data organizer (PDA), a web-enabled telephone system coupled to a telephone network, or a biometric system, operated by the user accessing the program remotely from the client 101.

Methods and systems consistent with the present invention are carried out by providing an input means 104, or user selection means, including hot clickable icons etc., or selection buttons, in a menu, dialog box, or a roll-down window of an interface provided at the client 101, and the user may input commands through a programmable stylus, keyboard, mouse, speech processing means, laser pointer, touch screen, or other input means 104.

The input or selection means 104 may be constituted by a dedicated piece of hardware or its functions may be executed by code instructions executed on the client processor 106, involving the display unit 102 for displaying the selection window and a stylus or keyboard for entering a selection, for example.

The client 101 typically includes a processor 106 as a client data processing means, the processor including a central processing unit (CPU) 107 or parallel processor and an input/output (I/O) interface 108, a memory 109 with a program 110 having a data structure 111, all connected by a bus 112. Further, as stated above, the client 101 would include an input device or means 104, a display 102, and may also include one or more secondary storage devices 113. The bus 112 may be internal to the client 101 and may include an adapter to a keyboard or input device 104 or may include external connections.

The imaging display device 102 for the present invention is a high resolution computer monitor, which could also be a touch screen monitor. Alternatively, the display device 102 can also include other touch sensitive devices including tablet, pocket PC, and plasma screens. The touch screen would be pressure sensitive and responsive to the input of a stylus 104, for example, which would be used to directly interact with the display device 102.

Note that with respect to the client system 101, the graphics user interface (GUI) is a client application written to run on existing computer operating systems which may be ported to other personal computer (PC) software, personal digital assistants (PDAs), biometric units, and cell phones, and any other digital device that has a screen or visual component and appropriate storage capability.

The processor 106 at the client 101 may be internal or external thereto, and executes a program 110 adapted to predetermined operations. The processor 106 has access to the memory 109 in which may be stored at least one sequence of code instructions comprising the program 110 and the data structure 111 for performing predetermined operations. The memory 109 and program 110 may be located within the client 101 or external thereto.

Note that at times the system of the present invention is described as performing a certain function. However, one of ordinary skill in the art would know that the program 110 is what is performing the function rather than the entity of the system itself.

The program 110 which runs the method and system of the present invention can include a separate program code for performing a desired operation, or may be a plurality of modules performing sub-operations of an operation, or may be part of a single module of a larger program 110 providing the operation.

The processor 106 may be adapted to access and/or execute a plurality of programs 110 corresponding to a plurality of operations. An operation rendered by the program 110 may be, for example, supporting the user interface, performing e-mail applications, etc.

The data structure 111 may include a plurality of entries, each entry including at least a first storage area that stores the databases or libraries of image files, for example. The data structure can also have alternative embodiments including those associated with the stored information as one of ordinary skill in the art would appreciate from the following descriptions.

The storage device 113 stores at least one data file, such as image files, text files, data files, audio, video files, etc., in providing a particular operation. The data storage device as storage means 113, may for example, be a database, including a distributed database connected via a network, for example. The database can be a computer searchable database and may be a relational database. The storage device may be connected to the server 120 and/or the client 101, either directly or through a communication network, such as a LAN or WAN. An internal storage device 113, or an external storage device 114 is optional, and data may also be received via a network and directly processed.

In methods and system consistent with the present invention, the client 101 may be connected to other clients 101 or servers 120, including administration, billing or other systems, via a communication link 116 as a client communication means, using a communication end port specified by an address or a port, and the communication link 116 may include a mobile communication link, a switched circuit communication link, or may involve a network of data processing devices such as a LAN, WAN, the Internet, or combinations thereof. In particular, the communication link may be to e-mail systems, fax, telephone, wireless communications systems such as pagers and cell phones, wireless PDA's and other communication systems.

The communication link 116 may be an adapter unit capable to execute various communications protocols in order to establish and maintain communication with the server 120, for example. The communication link 116 may be constituted by a specialized piece of hardware or may be realized by a general CPU executing corresponding program instructions. The communication link 116 may be at least partially included in the processor 106 executing corresponding program instructions.

In one embodiment consistent with the present invention, if a server 120 is used in a non-distributed environment, the server 120 would include a processor 121 having a CPU 122 or parallel processor which is a server data processing means, and an I/O interface 123, but may also be constituted by a distributed CPU 122 including a plurality of individual processors 121 on one or a plurality of machines. The processor 121 of the server 120 may be a general data processing unit, but preferably a data processing unit with large resources (i.e., high processing capabilities and a large memory for storing large amounts of data).

The server 120 may include a memory 124 with program 125 having a data structure 126 all connected by a bus 127. The bus 127 or similar connection line can also consist of external connections, if the server 120 is constituted by a distributed system. The server processor 121 may have access to a storage device 128 for storing preferably large numbers of programs for providing various operations to the users.

The data structure 126 may include a plurality of entries, each entry including at least a first storage area which stores data and image files, for example, but may also have alternative embodiments including that associated with other stored information as one of ordinary skill in the art would appreciate.

The server 120 may be a single unit or may be a distributed system of a plurality of servers 120 or data processing units, and may be shared by multiple users in direct or indirect connection to each other. The server 120 performs at least one server program for a desired operation, which is required in serving a request from the client 101.

The communication link 129 from the server 120 is preferably adapted to communicate with a plurality of clients.

The present invention is implemented in software which can be provided in a client and server environment or in a distributed system over a computerized network across a number of client systems. Thus, in the present invention, a particular operation may be performed either at the client or the server, at the edge of a network or at the center, or both. Therefore, at either the client or the server, or both, corresponding programs for a desired operation/service are available.

In a client-server environment, at least one client and at least one server are each connected to a network 220 such as a Local Area Network (LAN), Wide Area Network (WAN), and/or the Internet, over a communication link 116, 129. Interaction with users may be through secure and non-secure internet connectivity. Thus, the steps in the methods consistent with the present invention are carried out at the client or at the server, or at both, the server (if used) being accessible by the client over for example, the Internet using a browser application or the like.

The client system 101 may include communications via a wireless service connection. The server system 120 may include communications with network/security features, via a wireless server; which connects to, for example, voice recognition. However, one of ordinary skill in the art would know that other systems may be included.

In another embodiment consistent with the present invention, the client system may be a basic system, and the server may include all of the components necessary to support the software platform of the present invention. Further, the present client-server system may be arranged such that the client system can operate independently of the server system, but that the server system can be optionally connected. In the former situation, additional modules would instead be connected to the client system. In another embodiment consistent with the present invention, the client system and server system can be disposed in one system, rather being separated into two systems.

Although the above physical architecture has been described above as client-side or server-side components, one of ordinary skill in the art would know that the above components of the physical architecture may be in either client or server, or in a distributed environment.

Further, although the above-described features and processing operations may be realized by dedicated hardware, or may be realized as programs including code instructions executed on data processing units, it is further possible that parts of the above sequence of operations are carried out in hardware, whereas other of the above processing operations are carried out using software.

The underlying technology allows for replication to various other sites. Each new site can maintain “state” with its neighbors so that in the event of a catastrophic failure, other server systems can continue to keep the application running, and allow the system to load-balance the application geographically as required.

Further, although aspects of one implementation of the present invention are described as being stored in memory, one of ordinary skill in the art will appreciate that all or part of the methods and systems consistent with the present invention may be stored on or read from other computer-readable media, such as secondary storage devices, like hard disks, floppy disks, CD-ROM, a carrier wave received from a network such as the Internet; or other forms of ROM or RAM either currently known or later developed. Further, although specific components of the system have been described, one skilled in the art will appreciate that the system suitable for use with the methods and systems consistent with the present invention, may contain additional or different components.

In the present architecture, a plurality of servers are preferably co-located in a Network Service Provider (NSP) Co-Location Facility. This NSP provides a temperature and humidity controlled facility, rack space, and a high-speed Internet connection. In one embodiment, the present invention would include at least one web server, processing server, an Interactive Voice Response (IVR) server, and a database server.

In one embodiment consistent with the present invention, the application is operated by at least one company that uses at least one server to support its timekeeping/expenses.

In operation, the user can access the application via differing communication paths and terminal devices. For example, a user can access the application from any location having Internet access—i.e., worldwide. The workforces that enter time into the system can do so from any number of differing physical locations at any time period, via a number of differing communication paths, such as by using the Internet, by using a biometric hand reader, or by Interactive Voice Response (IVR), for example. Further, since the timekeeping is in real-time, this allows an employer to track and monitor time and expenses in a real-time manner.

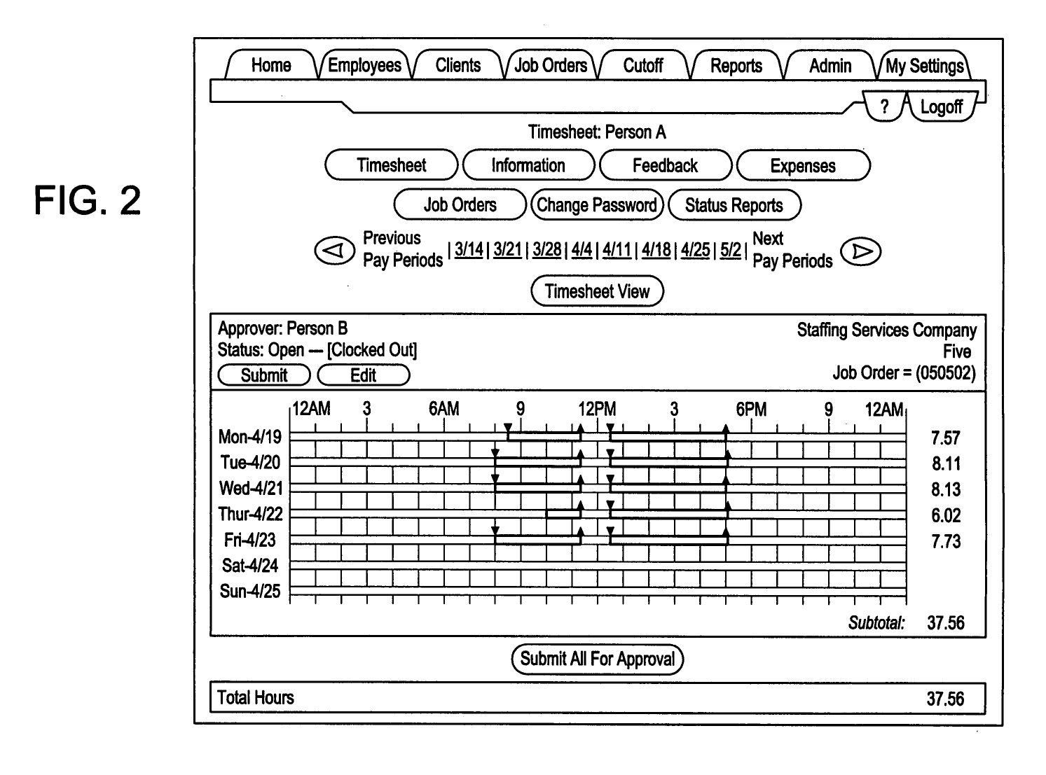

The GUI of the present invention is determined by the program 110 which creates GUI screen pages as shown in FIGS. 2-5. The method and apparatus of displaying the screens shown in FIGS. 2-5 is described below.

In a first embodiment consistent with the present invention, a temporary worker or user would utilize a personal computer (PC) with an Internet browser, to locate the time and attendance application, and log into the application using standard login procedures (i.e., username, passwords etc.). The user would then use a mouse or other navigational method or tool (i.e.; drop-down menus, stylus, etc.) to enter the time and attendance application, and when the program 110 provides a list of actions for the user to perform, the user would click on “Timesheet”.

The Clock-In/Clock-Out (CICO) timesheet used in the present invention, has a plurality of different forms. The standard Clock-In/Clock-Out CICO timesheet is shown in FIG. 2, and as stated above, provides the ability for a user to clock-in, clock-out, enter leaving for break, and enter returning from break—all in real-time. The standard timesheet can be a “bucket” type of timesheet where the total hours for a given day are entered by an employee. There is no record of when the employee actually worked the hours. However, project task accounting can be performed, so that an employee can itemize the hours they work against different projects and tasks. Reporting can then be done on these entered hours based on projects and tasks.

The CICO timesheet graphically displays user events that are generated from either the web-based application, or from hardware devices such as a biometric device, or from an IVR. One advantage of using a time and attendance application such as that of the present invention, is to provide a manager or administrative person, for example, the means to allow verification of an employee's time and attendance and working status at a given moment in time.

Specifically, the CICO timesheet as shown in FIG. 2, includes a graphical display for a seven day period, where a bar is divided into shift periods over 24 hours; In one embodiment consistent with the present invention, the bar in FIG. 1 can be designated or shaded by the GUI/program 110 to denote different shifts, as well as standard time and overtime. If shading is used, the shading used on the bars can be of any color or any type of shading, as long as it differentiates between the shifts and standard time or overtime.

Thus, once the user logs onto the time and attendance application and accesses the timesheet option, the program 110 would display on the screen 102 a CICO timesheet in bar-graph form, for example, and then the user would click on the day/date, and then click on the start time and the end time. The program 110 would then show the time worked in a darkened bar-form on the screen 102, for example, and provide the calculated hours worked to the right of the bar-graph. The total hours worked would be added and provided on the screen 102.

The timesheet screen (see FIG. 2) provides views of previous and future pay periods by week, which can be clicked on (the dates are underlined, denoting that an expanded view is available), so that the program 110 can display the days/dates for each of the seven days of that week, shown in hourly increments along a bar graph. The status of the employee (i.e., clocked out), as well as job order numbers etc., are displayed by the program 110. Further, in another embodiment consistent with the present invention, shifts can be shown (see below). The timesheet can be edited, and the user can access other information, such as Feedback, an Expense sheet, Job Orders, Status Reports, and can perform certain tasks, such as changing their passwords. Once the user enters time into the system, their hours are automatically calculated and totaled by the program 110, and displayed on the screen 102.

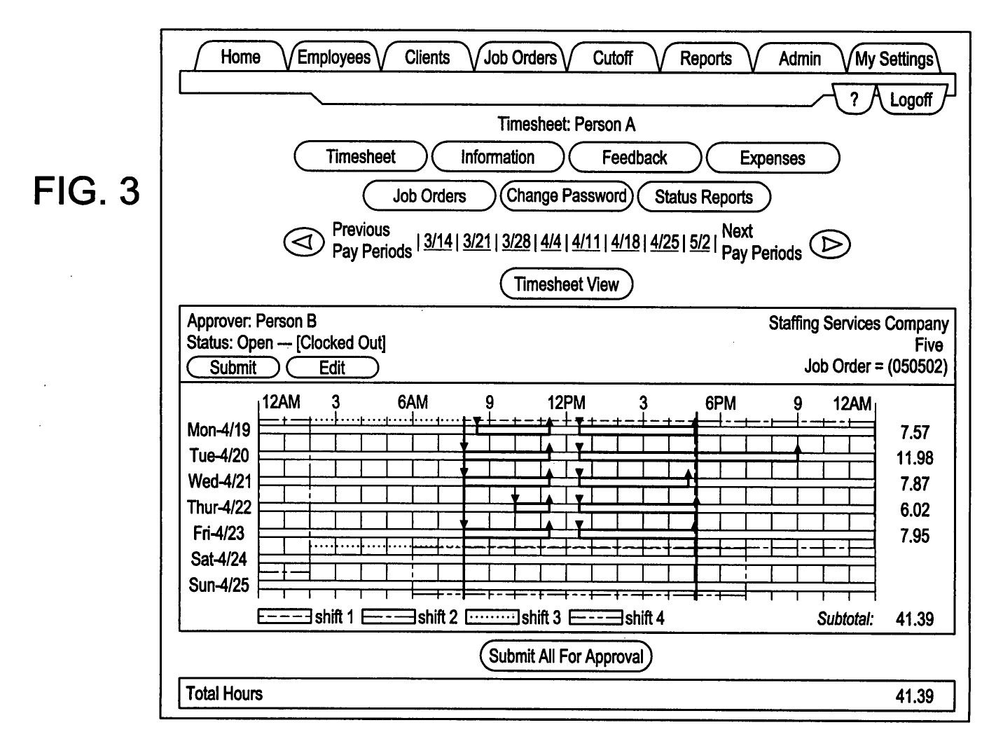

In another more advanced timesheet, as shown in FIG. 3, for example, shifts can be shown. In FIG. 3, it can be seen that the employee is assigned to four (4) shifts where each shift is denoted by a different designation, or color, for example. Noting the employee's time and attendance on Tuesday, for example, the program 110 displays on the screen 102 information that the viewer can review to ascertain that the employee worked over eight (8) hours. When overtime is entered by the employee, the program 110 makes the timesheet bar change designation (i.e., turn red or any other color), to denote that the employee has started accruing overtime and has moved into shift 2. This graphical representation of the employee's time as a bar graph by the program 110 and the GUI, shows both standard time and overtime for the shifts.

Once all the information is entered and totaled etc., the user can then log out from the time and attendance application.

As stated above, the time and attendance program is in real-time, and other parties such as the client and the time and attendance application staff, can view the entered time instantaneously.

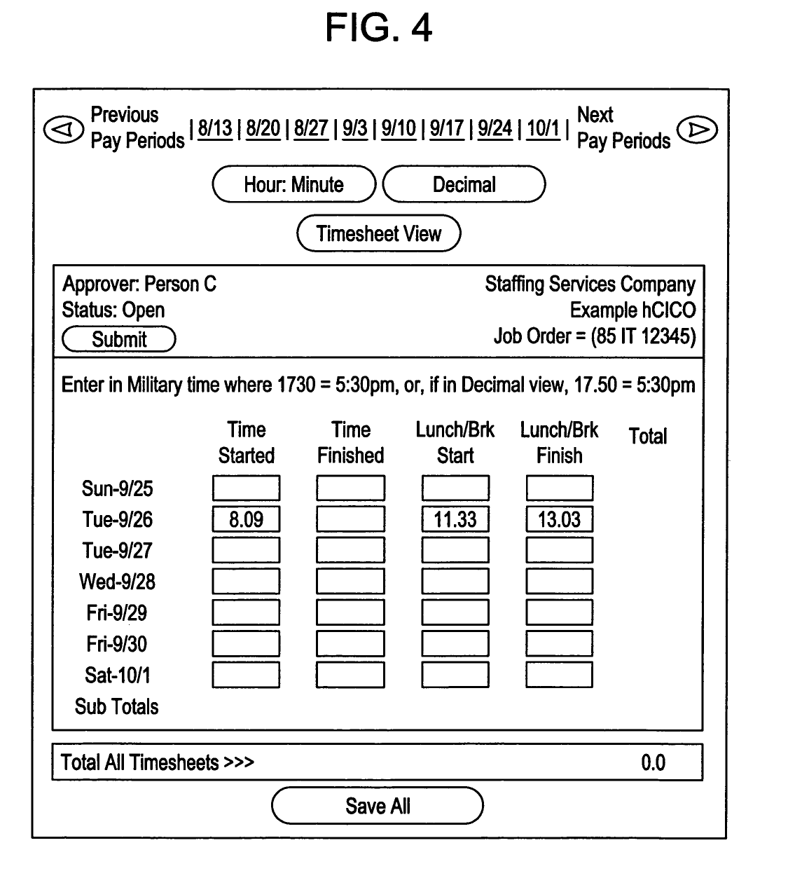

Another embodiment consistent with the present invention includes a hybrid CICO timesheet as shown in FIG. 4. The program 110 displays a timesheet on the screen 102 which appears like a paper timesheet, and provides a seven (7) day week format with columns having entry boxes for Time Started, Time Finished, Lunch/Break Start, Lunch/Break Finish, for example, and a Total column. Although the hybrid CICO timesheet is displayed by the program 110 in a tabular format to the user or temporary worker, the program 110 translates the tabular timesheet to that of a graphical form of the Standard CICO timesheet (see FIGS. 2-3). Thus, the authorized and responsible personnel reviewing the timesheet only sees the view of the graphical CICO timesheet, not the tabular form that the user actually completes.

In another embodiment consistent with the present invention, a group timesheet is used with a Professional Employer Organization (PEO) or Vendor on Premise (VOP), where either a Client Manager or a Staffing Service Administrator is entering time for an employee. The employee is not involved with the time and attendance system in this embodiment. The Manager enters and approves the time for the employee.

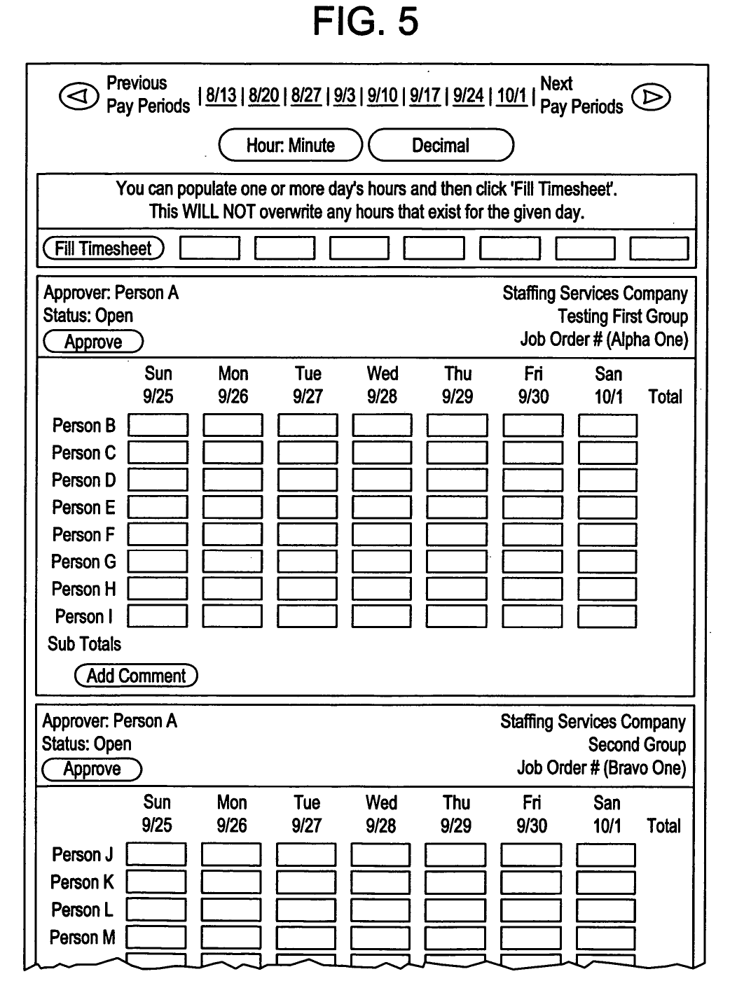

In this embodiment (see FIG. 5), the display is similar to that of the hybrid CICO timesheet, except that the administrator is entering time for more than one employee. The program 110 displays more than one employee's time sheet on the screen 102.

In one embodiment consistent with the present invention, the administrator can pre-populate the timesheet by entering in eight (8) hours for a workday, for example, and then clicking on Fill Timesheet. The program 110 then will populate all the timesheet's hours for 8 hours for each day. An exception can be made if the employee worked less than 8 hours; thus, editing can be performed as in all the timesheets.

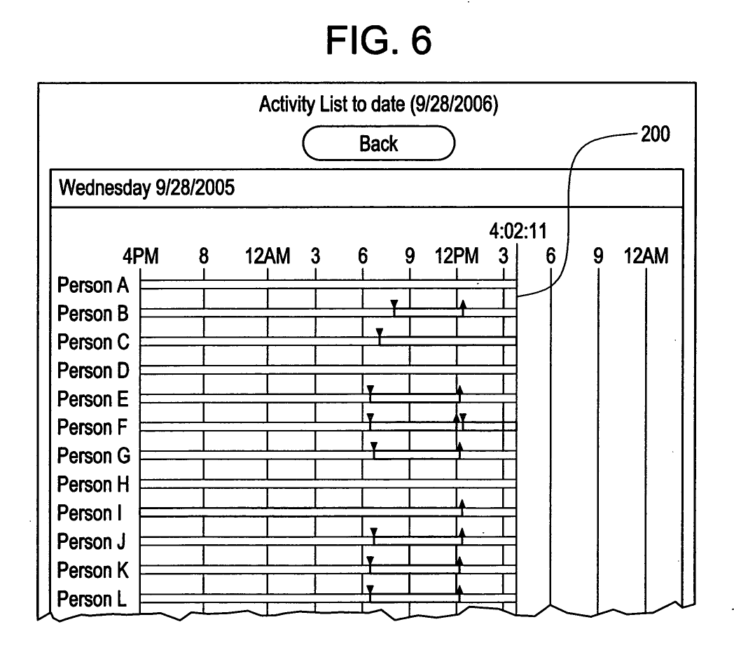

In another embodiment consistent with the present invention, as shown in FIG. 6, this CICO timesheet is used by one or more managers or a staffing service administrator, in order to see multiple employees' punch status for a 36 hour period, for example. Previous days may also be shown in addition to the 36 hour period. As shown in FIG. 6, the names of the employees are shown, alphabetically, for example, and the bar graph shows the 36 hour period. The eight (8) hour periods are displayed by the program 110 using different predetermined designations, such as color bars, for example, during that 8 hour time period; The line 200 in the graph, shows the current time. As the time progresses, the program 110 makes the line 200 move to the right and the bar becomes filled in.

To differentiate those employees who are on the clock currently, their time on the bar is shown by the program 110 in a designated form or color (i.e., green; for example), to the line 200, which is the current time (in other words, the employees who are on the clock are shown in real-time).

As stated above, the employee can enter their time in any one of online, biometric, as well as IVR forms, depending on the requirements of the job they are performing.

If the reviewer clicks on the employee's name in the list, the program 110 will then display the employee's full CICO timesheet for the current pay period on the screen 102. If the reviewer clicks on the Back button, the multiple employee display is once again shown by the program 110.

In another embodiment consistent with the present invention, the time and attendance application can be utilized via a biometric system (i.e., hand reader, fingerprint reader, facial recognition system, etc.) as a client 101. For example, a biometric hand reader 101 allows a user to enter their identification code when the user places their hand in the hand reader 101. The hand reader 101 then scan's the user's hand in a three-dimensional format and the program 110 confirms that the user's hand corresponds to the identification that was entered. The program 110 captures a specific time when the identification is confirmed, along with the user's choice of clocking in, clocking out, or starting or returning from break. The hand reader 101 can store up to 5,000 such events, for example, before having to be purged or downloaded.

The time and attendance application program 110 communicates with the hand reader device 101, and downloads the user events into the time and attendance application database. After a download occurs, the program 110 graphically updates the CICO timesheets so that all the responsible or authorized parties (i.e., client, user, time and attendance application system reviewers, etc.) can view the timesheets or events.

In yet another embodiment consistent with the present invention, a user can call a toll-free telephone number using a Public Switched Telephone Network (PSTN) or Voice Over Internet Protocol (VOIP) connection to utilize an Interactive Voice Response (IVR) system, as a client 101. The user will be prompted by the program 101 (in any format—speech, text, etc.), to enter their identification number along with a password—either verbally using speech recognition means, and/or by punching in the numbers on the phone pad. Upon verification of the identification number and password by the program 110, the IVR system will inform the user of their current “punch” status, such as clocked in/out, or on/off break, over the telephone or VOIP (i.e., verbally). The user is then presented by the program 110 with the appropriate choices based on their punch status, such as clocking in/out, going on/returning from break. Once the user makes the selection, the selection is entered into the database by the program 110, along with the capture of the actual time. All responsible or authorized parties can see this updated data instantaneously (i.e., in real-time).

Other features of the present invention which are accessed by the staffing company are described below.

For example, the staffing company will be able to view a Clients screen, in which the program 110 will display a list of clients (i.e.,.employers), which are searchable by the program 110, by name or identification number. The current status of the client, such as Active, Inactive, and/or Suspended can also be displayed by the program 110, for example, by checking a Status Display checkbox. New clients can be added in this screen.

An Employees screen allows the program 110 to display a list of employees currently in the system. The program 110 can search the employees by name and identification number. The current status of the employee, such as Assigned, Unassigned, Inactive and/or Terminated, can also be displayed by the program 110, for example, by checking the Status Display checkbox. New Employees can be added in this screen.

A Job Orders screen allows the program 110 to display a list of job orders currently in the system, which are searchable by the program 110 by client name or job order number. The current status of the jobs, such as Open, on Hold, Inactive, and/or Closed, can be displayed by the program 110, for example, by checking the Status Display checkbox. New Job Orders can be added from this screen.

A Cutoff screen allows the user to view the timesheet statuses of the employees in the system. By performing the Cutoff process, the program will take the timesheet information and export it to a bookkeeping application, for example. The information on this screen is searchable by the program 110 for client name and identification number. Also, the program 110 can display the timesheets that are currently In Progress, Submitted, Needs Attention, Closed, and Cutoff, for example, by checking the Status Display checkbox.

A Reports screen allows the user to instruct the program 110 to run various reports that pertain to the client, to the employee, and to the Job Orders. The reports displayed by the program 110, are broken up by department, for example, and provide information most pertinent to that department.

For example, for the Accounting department, client hours with pay (i.e., client identification, name, pay period, total hours, bill and pay amounts), client margin (i.e., client identification, name, total bill and pay amount with percent margin), employee hours (i.e., employee identification, name, and total hours), employee hours with pay (employee identification, name, pay period, total hours, bill and pay amounts), expense report status (i.e., employee identification, name, expense report name, open date, report status), timesheet overage (i.e., employee identification, client name, job order name, pay period, total hours, and number of hours over provided threshold), for example, can be displayed by the program 110.

For the Human Resources department, employee feedback (i.e., employee identification, name, date feedback was added, origin of feedback, feedback type, and first 40 characters (for example) of feedback), an employee list (i.e., employee identification, name, date added, placement status, phone number), employee utilization (i.e., employee identification, name, pay period, total house, percentage of hours over provided threshold), timesheet activity (i.e., employee identification, name, client name, job order name, pay period, current timesheet status), timesheet status (i.e., employee identification, name, pay period, timesheet status), and user list (i.e., name, date added, user type, current status), for example, can be displayed by the program 110.

For the Sales department, client hours (i.e., client identification, name, total hours), client list (i.e., client identification, name, date added, current status), client utilization (i.e., client identification, name, pay period, total hours, employee count, percentage utilization form provided threshold), employee margin (i.e., employee identification, name, total bill and pay amounts, percent margin), and job order status (i.e., job order number, title, client name, status, open date, close date, total hours), for example, can be displayed by the program 110.

The Admin screen allows the program 110 to display all of the staffing company's personnel, allows the user to generate messages to send to the company and its personnel, maintain user information, maintain a notification system, and toggle internal timesheet and expense reporting capabilities, for example. Searches can be performed by the program 110 on the user using their last name and login name, for example. The program 110 can also display those users who are currently Active and/or Terminated by checking the Status Display checkbox, for example.

Finally, the My Settings screen allow the user to enter their own profile information which is saved by the program 110. User defaults, such as user mode, timesheet format, and default page count, secret question and answer, and password, for example, can be modified by the program 110.

With respect to the client's screens, the program 110 of the present invention will display screens that include the following.

For example, as discussed above, the client will be able to view timesheet screens of the employees, and also will have tabs that allow them to access Home (where the program 110 will show any messages sent by the staffing company), Employees (a listing of all the employees the client manager is responsible for managing, and where information on the employee's timesheet, profile, feedback and status reports are available), Approval (where the employee timesheets can be approved individually or in a group), Reports (employee feedback, employee hours, employee hours with pay, expense report status, project summary, project summary with pay, project/task code summary, project/task code with pay, task code summary, task code summary with pay, timesheet overage, and timesheet status), Projects (where projects and tasks can be created against which hours are posted by the employees), Admin(where the client can view all managers for the company in which they work, and create new managers for projects), and My Settings (where they can view their profile information, and where user defaults can be modified (i.e., user mode, timesheet format, default page count, secret question, and user password)).

The Project information may include project or task (code) title, project or task code, open and close date, employee name, total hours, and regular and overtime pay.

With respect to the Employee's screens, the program 110 of the present invention will display screens that include the following.

For example, as discussed above, the employee will have a timesheet screen, and will also have a tab that allows them to access Home (where the program 110 will show any messages sent by the staffing company), Contacts (where the contact supervising manager information and information of the staffing company person that supervises the employee), Job Orders (i.e., profile information about the job(s) to which the employee is assigned), Reports (where status reports can be completed, and also expense reports, for example), and My Settings (to view profile information of the employee, and where user defaults can be modified (i.e., timesheet format, default page count, secret question, and user password)). In addition, a Comment button is provided for the employee to add any comment they would like to save.

With respect to the Expenses tab on the timesheets, this screen allows the user to create an expense report, where an expense is entered, an entity/manager responsible for reviewing, approving, and paying the expense is entered (i.e., staffing service or client), and report name, for example. The program 110 stores the expense report and sends an e-mail to the manager for review and approval of the expense report (i.e., Mark as Paid, or Unsubmit for redoing and resubmission).

Accordingly, a number of different features can be shown to users on different screens in real time, simultaneously.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of generating a GUI screen for time and attendance, comprising:
displaying a timesheet in a graphical bar format;
receiving time entries in said timesheet;
displaying said time entries along said graphical bar; and
totaling said time entries.

2. The method according to claim 1, wherein said time entries are displayed in real time to a user.

3. The method according to claim 1, wherein said time entries are received from one of a web-based application, a biometric device, and an interactive voice response system.

4. The method according to claim 2, wherein said time entries are viewed in real time by other users.

5. The method according to claim 2, wherein said graphical bar format includes differing portions displaying different shift periods.

6. The method according to claim 5, wherein said differing portions include one of differently colored and shaded portions.

7. The method according to claim 2, wherein said graphical bar format includes differing portions displaying overtime.

8. The method according to claim 2, further comprising:
displaying a working status of the employee.

9. The method according to claim 2, further comprising:
displaying a job order being worked on by the employee.

10. The method according to claim 1, wherein said timesheet is for a plurality of employees working on a plurality of job orders.

11. The method according to claim 10, wherein said timesheet can be prepopulated for a standard number of working day hours by inputting one time entry.

12. The method according to claim 1, wherein, a predetermined time period can be viewed up to and including current time.

13. The method according to claim 12, wherein current time is displayed as one of a vertical line which moves across the screen as time progresses, and a different shading on said graphical bar.

14. The method according to claim 12, wherein said predetermined time period is a current pay period.

15. The method according to claim 3, wherein said biometric system allows a feature of a user's physical appearance to be scanned into the system for purposes of identification; and wherein the system notes a time scanned for purposes of time and attendance.

16. The method according to claim 15, wherein said time scanned is entered into said timesheet as a time entry for display in said graphical bar format

17. The method according to claim 3, wherein said interactive voice response system receives input from a user for identification purposes, and for purposes of time and attendance.

18. The method according to claim 17, wherein said input and said information is processed using a speech recognition mechanism.

19. The method according to claim 17, wherein the system provides the user with information on their current working status.

20. The method according to claim 1, wherein said time entries are exported to an accounting program.

21. The method according to claim 1, further comprising:
receiving expense entries; and
forwarding said expense entries for approval.

22. A method of generating a GUI screen for time and attendance, comprising:
displaying a timesheet in a standard column format;
receiving time entries from a user in said timesheet; and
displaying said timesheet with said time entries to other users in a graphical bar format in real-time.

23. A method of generating a GUI for time and attendance, comprising:
displaying a plurality of screens for viewing by a plurality of different users, said screens including at least one of a clients screen, an employees screen, a job orders screen, a cutoff screen, and a reports screen;
wherein said screens can be displayed simultaneously; and
wherein said screens are displayed in real time.

24. A computer system having a program for generating screens for time and attendance, comprising:
means for displaying a timesheet in a graphical bar format;
means for receiving time entries in said timesheet;
means for displaying said time entries along said graphical bar; and
means for totaling said time entries.

25. The computer system according to claim 24, wherein said time entries are displayed in real time to a user.

26. The computer system according to claim 24, wherein said time entries are received from one of a web-based application, a biometric device, and an interactive voice response system.

27. A computer system having a program for generating screens for time and attendance, comprising:
means for displaying a timesheet in a standard column format;
means for receiving time entries from a user in said timesheet; and
means for displaying said timesheet with said time entries to other users in a graphical bar format in real time.

28. A computer system having a program for generating screens for time and attendance, comprising:
means for displaying a plurality of screens for viewing by a plurality of different users, said screens including at least one of a clients screen, an employees screen, a job orders screen, a cutoff screen, and a reports screen;
wherein said screens can be displayed simultaneously; and
wherein said screens are displayed in real time.

29. A computer system for generating screens for time and attendance, comprising:
at least one memory containing at least one program comprising the steps of:
displaying a timesheet in a graphical bar format;
receiving time entries in said timesheet;
displaying said time entries along said graphical bar; and
totaling said time entries; and
at least one processor for running the program.

30. The computer system according to claim 29, wherein said time entries are displayed in real time to a user.

31. The computer system according to claim 29, wherein said time entries are received from one of a web-based application, a biometric device, and an interactive voice response system.

32. A computer system for generating screens for time and attendance, comprising:
at least one memory containing at least one program comprising the steps of:
displaying a timesheet in a standard column format;
receiving time entries from a user in said timesheet; and
displaying said timesheet with said time entries to other users in a graphical bar format in real time; and
at least one processor for running the program.

33. A computer system for generating screens for time and attendance, comprising:
at least one memory containing at least one program comprising the steps of:
displaying a plurality of screens for viewing by a plurality of different users, said screens including at least one of a clients screen, an employees screen, a job orders screen, a cutoff screen, and a reports screen;
wherein said screens can be displayed simultaneously; and
wherein said screens are displayed in real time; and
at least one processor for running the program.

34. A computer-readable medium whose contents cause a computer system to generate screens for time and attendance, the computer system having a program comprising the steps of:
displaying a timesheet in a graphical bar format;
receiving time entries in said timesheet;
displaying said time entries along said graphical bar; and
totaling said time entries.

35. The computer system according to claim 34, wherein said time entries are displayed in real time to a user.

36. The computer system according to claim 34, wherein said time entries are received from one of a web-based application, a biometric device, and an interactive voice response system.

37. A computer-readable medium whose contents cause a computer system to generate screens for time and attendance, the computer system having a program comprising the steps of:
displaying a timesheet in a standard column format;
receiving time entries from a user in said timesheet; and
displaying said timesheet with said time entries to other users in a graphical bar format in real time.

38. A computer-readable medium whose contents cause a computer system to generate screens for time and attendance, the computer system having a program comprising the steps of:
displaying a plurality of screens for viewing by a plurality of different users, said screens including at least one of a clients screen, an employees screen, a job orders screen, a cutoff screen, and a reports screen;
wherein said screens can be displayed simultaneously; and
wherein said screens are displayed in real time.
